(19) United States
(12) Patent Application Publication
(10) Pub. No.: US 2002/0120742 A1
(43) Pub. Date: Aug. 29, 2002

(54) Dynamic user interface for facilitating network device capability utilization

(76) Inventor: Darrel D. Cherry, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/784,946

(22) Filed: Feb. 14, 2001

(51) Int. Cl. G06F 15/173

(52) U.S. Cl. 709/226

(57) ABSTRACT

A preferred method includes the steps of: determining attributes of network devices communicating with the network; enabling a user to select desired attributes of a network device for processing a job; and facilitating processing of the job at one of the network devices corresponding to the desired attributes selected by the user. In some embodiments, the network devices may be printers, and the aforementioned job is a print job. Systems and computer readable media also are provided.

### BACKGROUND OF THE INVENTION

### FIELD OF THE INVENTION

The present invention generally relates to computer networks and, in particular, to systems and methods for facilitating network device capability utilization within a computer network.

### DESCRIPTION OF THE RELATED ART

Network devices, such as printers and workstations, among others, may be provided in a network environment in which various ones of the devices are be configured to communicate with various others of the device. Typically, such a network environment is facilitated by use of a network server which coordinates communication traffic between and among the various network devices.

Use of a network has, heretofore, allowed users of various network devices, e.g., workstations, to communicate with various other network devices, such as one or more printers, for example, of the network. For instance, it is common in a network environment for a user to have access to a printer which may be somewhat remote from the user's workstation. Typically, the user becomes familiar with the capabilities of such a printer, such as by utilizing of the printer, and, thus, is able to determine when utilizing that printer is appropriate for a particular print job. However, there are times when a particular printer may not be available for use, such as when the printer is removed from service for maintenance, for instance. At such times, when the user requires a print job to be processed, the user typically must then identify an alternative printer for processing the print job. However, if the user is unaware of the capabilities of other printers available via the network, processing of the print job becomes problematic.

In other situations, a printer may be added to an established network, for instance, and a user may be unaware of the particular print capabilities associated with the newly added printer. Thus, although the user may desire utilizing printer capabilities such as those possessed by the newly added printer, those capabilities may remain unrecognized and, therefore, unutilized. Moreover, even if the user were to recognize the capabilities of the newly added printer, the user would be unable to utilize the new printer until the workstation of the user was reconfigured to utilize those new capabilities, e.g., software associated with the new printer is installed on the user's workstation. Thus, in a network of many workstations, for example, a newly added printer may remain unavailable to one or more workstations of the network for an extended period of time, more specifically, the time that it takes to have the printer software installed on those workstations.

Therefore, there is a need for improved systems and methods that address these and other shortcomings of the prior art.

### SUMMARY OF THE INVENTION

Briefly stated, the present invention relates to network device capability utilization within a computer network. In this regard, embodiments of the present invention may be construed as providing methods for facilitating network device capability utilization within a network. In a preferred embodiment, the method includes the steps of: determining attributes of network devices communicating with the network; enabling a user to select desired attributes of a network device for processing a job; and facilitating processing of the job at one of the network devices corresponding to the desired attributes selected by the user. In particular, in some embodiments, the network devices may be printers, and the aforementioned job is a print job.

Some embodiments of the present invention may be construed as providing systems for facilitating network device capability utilization within a network. In a preferred embodiment, the system includes a user interface system that communicates with a network. The user interface system, which, in some embodiments, may be facilitated by a network server, is configured to determine attributes of network devices communicating with the network. Preferably, the user interface system provides a user interface, such a graphical user interface which may be displayed upon the display device of a user workstation, for example. The user interface is configured to enable a user to select desired attributes of a network device for processing a job so that the user interface system may facilitate processing of the job at one of the network devices corresponding to the desired attributes selected by the user.

In other embodiments, the system may incorporate means for determining attributes of network devices communicating with the network, means for enabling a user to select desired attributes of a network device for processing a job, and means for facilitating processing of the job at one of the network devices corresponding to the desired attributes selected by the user.

Still other embodiments of the present invention may be construed as providing computer readable media. In a preferred embodiment, the computer readable medium includes a computer program for facilitating network device capability utilization within a network. Preferably, the computer readable medium incorporates logic configured to determine attributes of network devices communicating with the network, logic configured to enable a user to select desired attributes of a network device for processing a job, and logic configured to facilitate processing of the job at one of the network devices corresponding to the desired attributes selected by the user.

Other features and advantages of the present invention will become apparent to one with skill in the art upon examination of the following drawings and detailed description. It is intended that all such features and advantages be included herein within the scope of the present invention, as defined in the appended claims.

### BRIEF DESCRIPTION OF THE SEVERAL VIEWS OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting a preferred embodiment of the present invention.

FIG. 2 is a schematic diagram depicting a computer or processor-based system which may employ a preferred embodiment of the present invention

FIG. 3 is a flowchart depicting the functionality of a preferred embodiment of the present invention.

FIG. 4 is a flowchart depicting the functionality of an alternative embodiment of the present invention.

FIG. 5 is a schematic diagram depicting a representative graphical user interface which may facilitate utilization of a preferred embodiment of the present invention.

FIG. 6 is a schematic diagram depicting a representative graphical user interface provided by a preferred embodiment of the present invention.

FIG. 7 is a schematic diagram depicting a representative graphical user interface provided by a preferred embodiment of the present invention.

FIG. 8 is a flowchart depicting the functionality of an alternative embodiment of the present invention.

### DETAILED DESCRIPTION OF THE PREFERRED EMBODIMENT

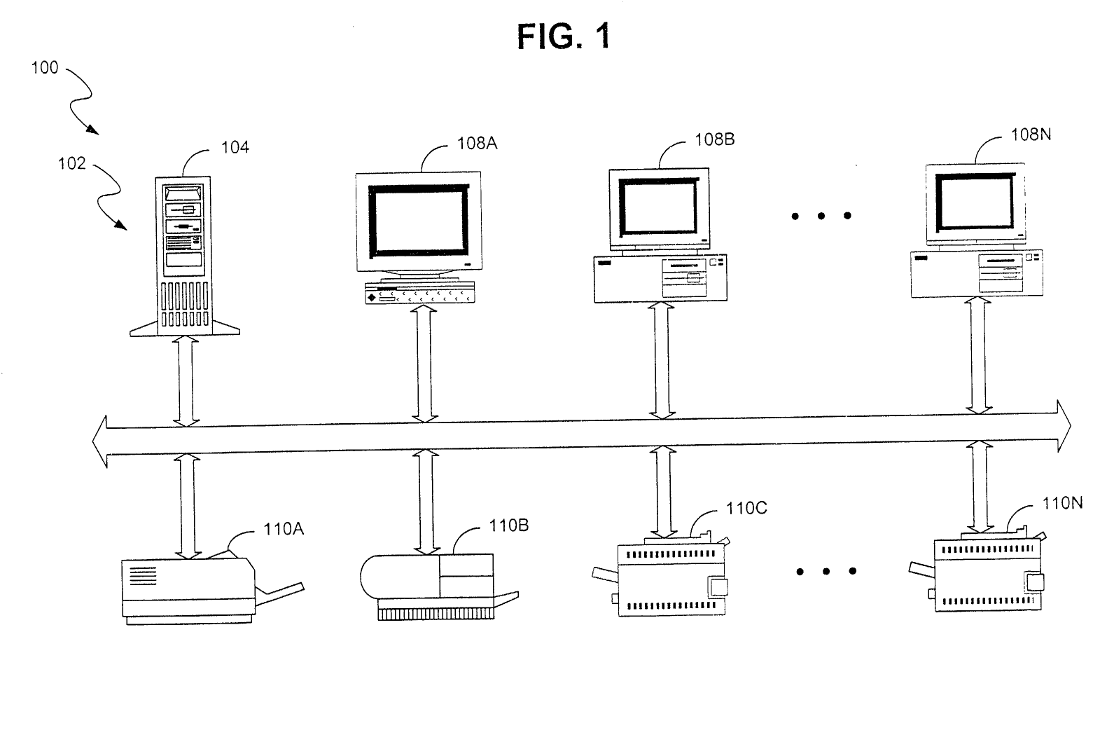

Referring now to the figures wherein like reference numeral indicate corresponding parts throughout the several views, FIG. 1 depicts a preferred embodiment of the dynamic user interface system 100 of the present invention which may facilitate enhanced operability of a network 102. As shown in FIG. 1, network 102 incorporates a network server 104 which enables intercommunication between one or more user devices, such as workstations 108A, 108B-108N, as well as one or more printers, such as printers 110A, 110B, 110C-110N. So provided, a user operating at one of the workstations may request that a print job be executed by one or more of the printers communicating with the network. As described in detail hereinafter, the present invention preferably facilitates efficient recognition of capabilities of printers intercommunicating with the network, thereby facilitating efficient utilization of such capabilities.

Embodiments of the dynamic user interface system and associated methodology of the present invention may be implemented in hardware, software, firmware, or a combination thereof. In a preferred embodiment, however, the present invention is implemented as a software package, which can be adaptable to run on different platforms and operating systems as shall be described further herein. In particular, a preferred embodiment of the dynamic user interface system, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. As such, the dynamic user interface system of the present invention may reside on a network server (server 104 of FIG. 1), for example, or on any other device or apparatus which may communicate with the network of interest.

In the context of this document, a “computer-readable medium” can be any means that can contain, store, communicate, propagate or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable, programmable, read-only memory (EPROM or Flash memory) (magnetic), an optical fiber (optical), and a portable compact disk read-only memory (CDROM) (optical). Note that the computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

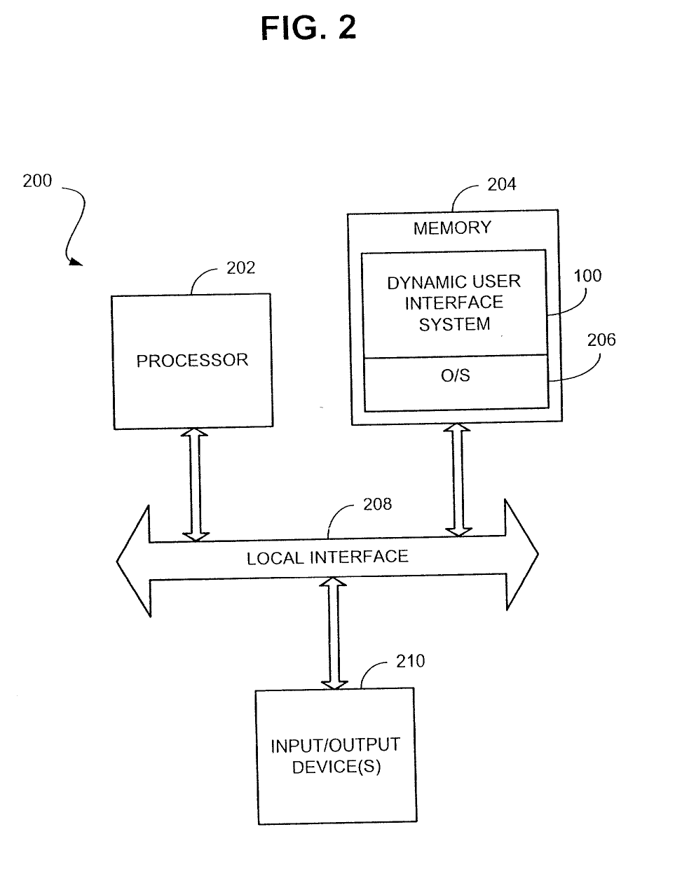

Referring now to FIG. 2, a preferred embodiment of the dynamic user interface system 100 will be described in greater detail. As shown in FIG. 2, a computer or processor-based system 200, which may facilitate the dynamic user interface system 100 and associated methodology of the present invention, generally comprises a processor 202 and a memory 204 with an operating system 206. Herein, the memory 204 may be any combination of volatile and nonvolatile memory elements, such as random access memory or read only memory. The processor 202 accepts instructions and data from memory 204 over a local interface 208, such as a bus(es). The system also may include an input/output device(s) 210. Examples of an input/output device may include, but are not limited to, a serial port, a local access network connection, or a Universal Serial Bus. Generally, system 200 may run any of a number of different platforms and operating systems, including, but not limited to, HP-UX™, Linux™, Unix™, Sun Solaris™ or Windows NT™ operating systems. The dynamic user interface system 100 of the present invention, the functions of which shall be described hereinafter, resides in memory 204 and is executed by the processor 202.

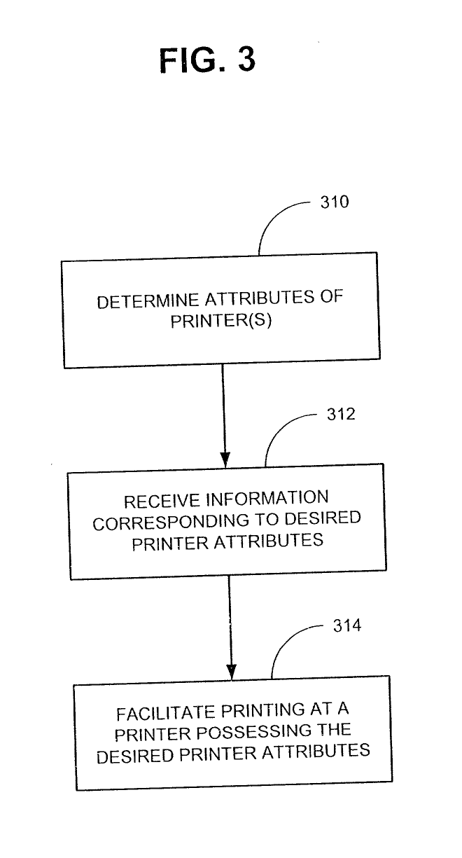

Referring now to the flowchart of FIG. 3, that figure depicts the functionality of a preferred implementation of the dynamic user interface system and associated methodology of the present invention. In this regard, each block of the flowchart represents a module segment or portion of code which comprises one or more executable instructions for implementing the specified logical function or functions. It should also be noted that in some alternative implementations the functions noted in the various blocks may occur out of the order depicted in FIG. 3. For example, two blocks shown in succession in FIG. 3 may, in fact, be executed substantially concurrently where the blocks may sometimes be executed in the reverse order depending upon the functionality involved.

As depicted in FIG. 3, the functionality facilitated by a preferred embodiment of the dynamic user interface system of the present invention may be construed as beginning at block 310 where a determination is made as to the attributes of the printer or printers associated with a network. For example, and not for the purpose of limitation, the attributes may include processing capabilities, such as color, stapling, photo quality, duplex, wide format, high speed, and N-up, among others, and printer components, such as a mailer unit, and a photo finisher, among others. Thereafter, the system may receive information corresponding to desired printer attributes (block 312). For instance, a user may require that a print job be processed in a certain manner, e.g., by a printer possessing certain attributes. Thus, in block 312, the system may receive information from the user regarding desired printer attributes in relation to a particular print job. In response to receiving such information, the process may proceed to block 314 where printing of the user's print job may be facilitated at a printer possessing the desired attributes.

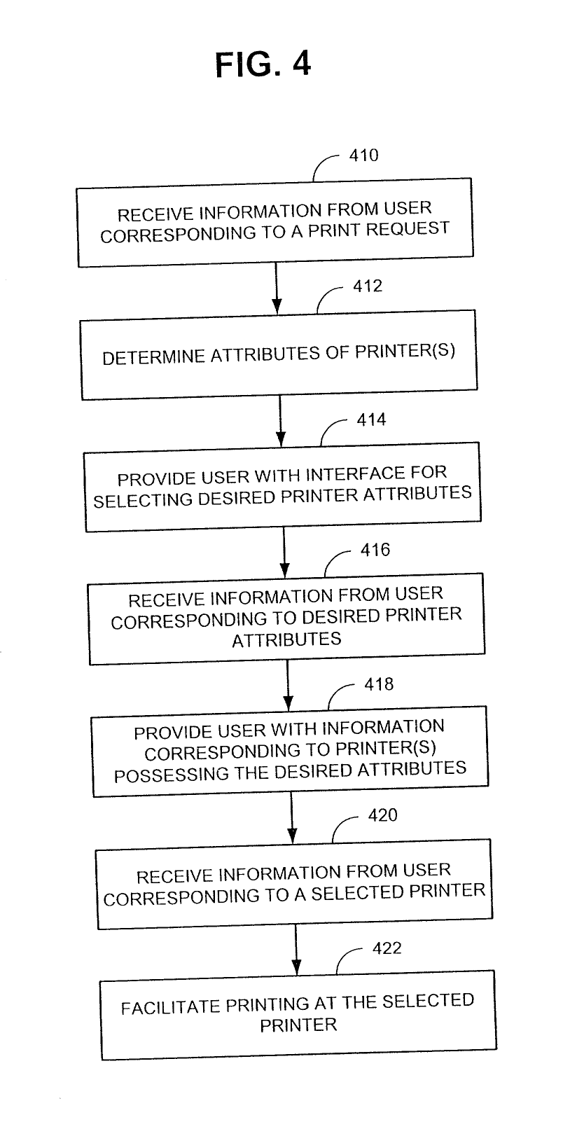

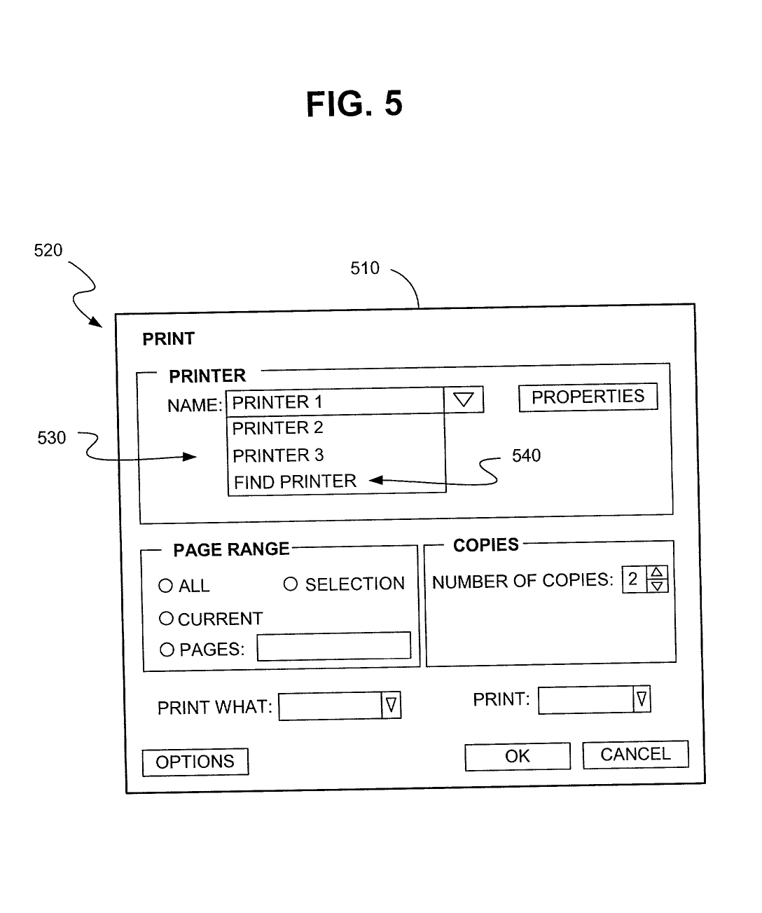

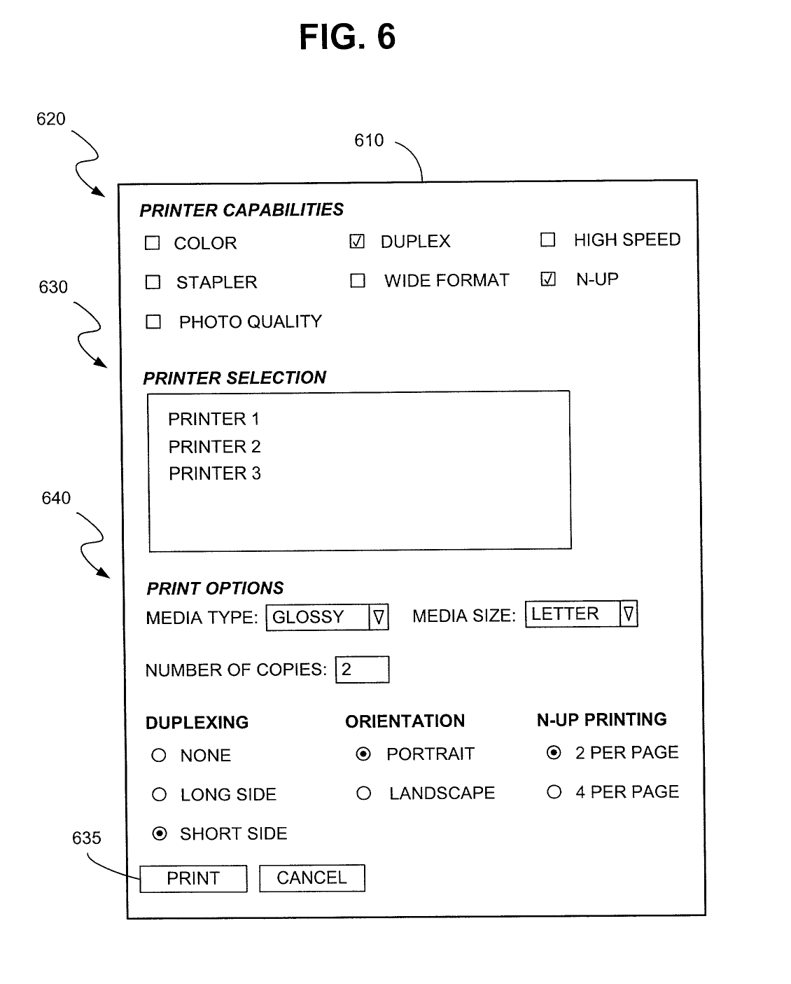

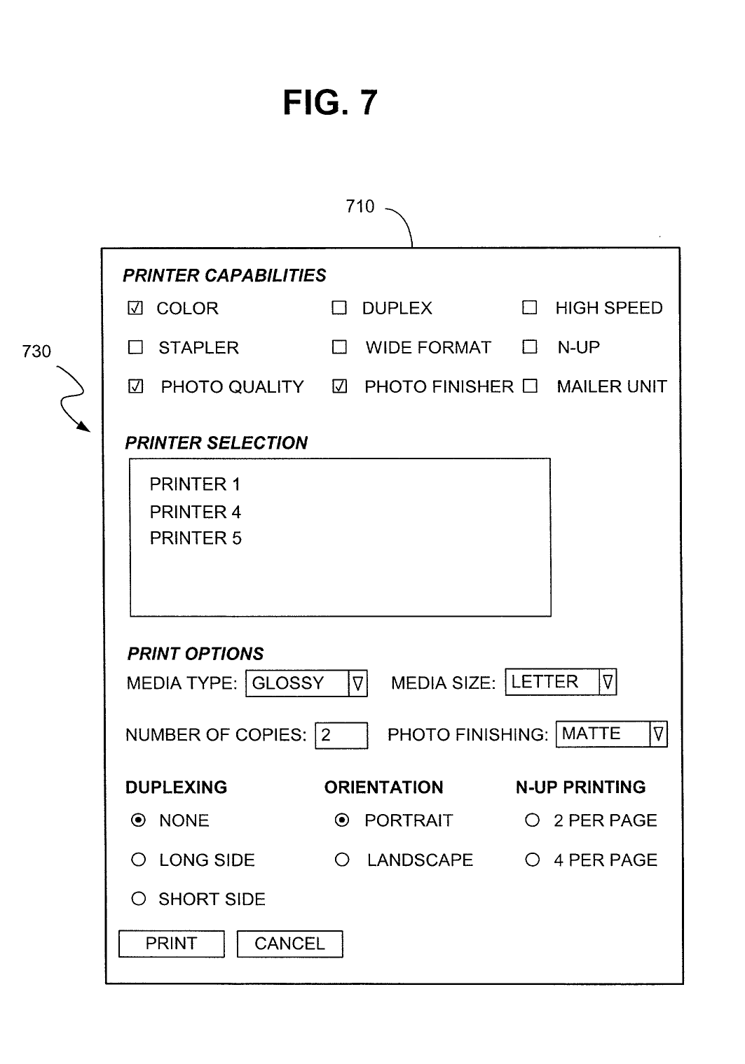

Reference will now be made to FIGS. 4-7, wherein FIG. 4 depicts the functionality of an alternative embodiment of the present invention, FIG. 5 depicts a representative graphical user interface which may facilitate utilization of the present invention, and FIGS. 6 and 7 depict sequential views of a representative graphical user interface provided by an embodiment of the present invention. As shown in FIG. 4, the functionality of the depicted alternative embodiment may be construed as beginning at block 410 where information from a user corresponding to initiation of a print request (initiating a print job, such as by selecting “File” and then “Print” when utilizing Word™ word-processing software from Microsoft®) is received. In response to receiving such information, the user may then be provided with a graphical user interface, such as representative user interface 510 of FIG. 5, which may be displayed upon a display device of the user's workstation, for example. Such an interface typically provides a user with a “Printer” field 520, within which a printer may be designated for printing the user's print job. Typically, if a desired printer is not currently selected/displayed in field 520, the user may actuate a drop-down menu, such as menu 530, for example, in a conventional manner, thereby enabling the interface 510 to display a list of printers potentially available for selection by the user. The user may then make a selection from the menu 530, such as by selecting the “Find Printer” icon 540.

In response to receiving information corresponding to the selection of the “Find Printer” icon 540, a determination may be made as to the attributes of the printer or printers associated with the network (block 412 of FIG. 4). As depicted in block 414, the user then may be provided with a graphical user interface (GUI) with which to select desired attributes of a printer, i.e., the printer to process the requested print job. In some embodiments, the graphical user interface may be a web-based GUI, i.e., the GUI is viewable via a web browser, with the GUI being generated from a mark-up language such as HTML or XML, for example, or from a scripting language, such as JAVA, for example. For example, the interface may provide the user with a list of selectable attributes, with the list being established based upon the aforementioned determination of attributes of the printer(s) associated with the network (block 410). Such an interface is depicted in the FIG. 6.

As shown in FIG. 6, a representative user interface 610, which may be displayed upon a display device of the user's workstation, for example, provides the user with a variety of information and/or selections from which to choose. For instance, the user interface preferably provides the user with a listing of printer attributes within a “Printer Capabilities” field 620. Preferably, each of the attributes correspond to an attribute of one or more of the printers currently associated with and available to the network. Thus, in the embodiment depicted in FIG. 6, the attributes of color, stapler, photo quality, duplex, wide format, high speed and N-up currently are available to the network via one or more of the network printers.

In order to select a particular one or ones of the attributes, e.g., attributes to be utilized when processing a requested print job, the user need merely select the attribute(s) of interest via the interface. As depicted in FIG. 6, the attributes of “duplex” and “N-up” have been selected, i.e., the selected attributes are designated by a check mark.

Based upon the attributes selected by the user, printer selection options may be presented to the user (see, blocks 416 and 418 of FIG. 4). For instance, in the embodiment depicted in FIG. 6, “Printer 1”, “Printer 2” and “Printer 3” are presented to the user in the “Printer Selection” field 630 of the interface. Thus, the system has determined that each of printers 1, 2 and 3 offers both duplexing and N-up functionality. Once presented with an appropriate printer selection, the user may select a printer from the “Printer Selection” field 630 for processing the requested print job, e.g., the user may select a printer by highlighting the designation corresponding to the desired printer in a conventional manner. It should be noted that, based upon the printer attributes selected by the user, there may not be a printer associated with the network that possesses the particular attributes desired by the user. Therefore, it is anticipated that, at times, no printers may be identified within the “Printer Selection” field 630 of the interface.

Once an appropriate printer has been selected by the user, information corresponding to the selected printer may be received by the dynamic interface system (depicted in block 420 of FIG. 4). The user then may request processing of the print job by the selected printer, such as by actuating icon 635 (the “Print” icon). Thereafter, the system may facilitate processing of the print job at the selected printer, such as shown in block 422 (FIG. 4). In some embodiments, if the user has not selected a particular printer from within the “Printer Selection” field 630 prior to requesting processing of the print job, e.g., actuating icon 535, a default printer selection may be facilitated by the present invention. Such a default may be based on one or more of numerous criteria including printer capacity, proximity of the printer to the user, etc..

Interface 610 (FIG. 6) also may provide the user with various print options 640. For example, various options such as media type, media size, number of copies, type of duplexing, orientation of page, and type of N-up printing, among others, may be provided. One or more of the presented options also may be selected by the user as desired, i.e., prior to requesting processing of the print job.

As mentioned hereinbefore, preferred embodiments of the present invention dynamically determine attributes of printers intercommunicating with the network. In this regard, reference is now made to the schematic diagram of FIG. 7 which depicts a graphical user interface 710 which is facilitated by the present invention. Much like the graphical user interface 610 depicted in FIG. 6, the graphical user interface 710 presents a user with a variety of printer attributes from which to choose. For the purpose of the present discussion, the graphical user interfaces 610 and 710, depicted in FIGS. 6 and 7 respectively, may well have been facilitated by the same embodiment of the present invention. However, it should be noted that one of the differences between the respective interfaces is that the printer attributes provided for selection by the interface 710 are modified as compared with the printer attributes presented in the interface 610. Modification of attributes presented to a user via the interface may occur when one or more printers intercommunicating with the network, and/or one or more printer attributes, changes.

In the representative example depicted in FIG. 7, it may be assumed that printers, e.g., printers 4 and 5, have been made available to the network. More specifically, printers 4 and 5 provide the additional attributes of both a photo finisher and a mailer unit to the list of selectable attributes presented in “Printer Selection” field 730. Therefore, when the user selects the desired attribute of a photo finisher, “Printer 4” and “Printer 5” are presented as being available for selection by the user.

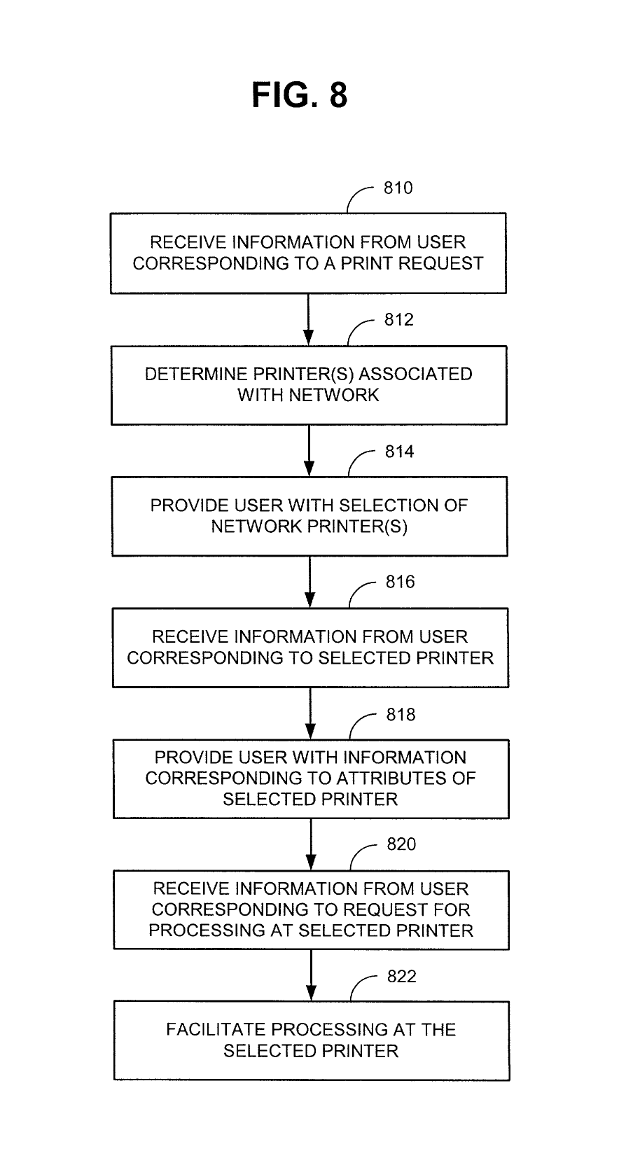

Referring now to FIGS. 8, the functionality of another embodiment of the present invention will be described in detail. As shown in FIG. 8, the functionality of the depicted alternative embodiment may be construed as beginning at block 810 where information from a user corresponding to initiation of a print request (initiating a print job) is received. In response to receiving the print request information, a determination may be made as to the printer or printers currently associated with the network (block 812). As depicted in block 814, the user then may be provided with a GUI which includes a list of printers, such a GUI may be facilitated by a network server, as described hereinbefore. For example, the GUI may provide the user with a list of selectable printers, with the list being established based upon the aforementioned determination of the printer(s) currently associated with the network (block 810). Referring briefly to the representative user interface 610 depicted in FIG. 6, such a listing of selectable printers may be provided in the “Printer Selection” field 630.

Once presented with printer selections, the user may select a printer, such as by highlighting the designation corresponding to a desired printer in a conventional manner. As depicted in block 816, information corresponding to the selected printer is received and, in response thereto, information corresponding to attributes associated with the selected printer then may be provided to the user (block 818). For instance, the GUI may display the attributes associated with the selected printer in the “Printer Capabilities” field 620 (FIG. 6). Attributes of printers of the network may be maintained in a database, for example, that may be updated at some interval and/or upon the occurrence of a particular event. Simple Network Management Protocol (SNMP), for example, may be utilized to facilitate such a database. Thus, when information corresponding to a selected printer is received by the system, the system may access the database, and determine from the database those attributes associated with the selected printer. Information corresponding those attributes then may be provided to the user.

Based upon the particular attributes of the selected printer, the user may choose to select another printer, e.g., in order to select a printer possessing a desired attribute. Thereafter, irrespective of the particular printer selected, the user may request printing via the selected printer and the dynamic user interface system may facilitate the appropriate processing (see, blocks 820 and 822).

It should be noted that the various embodiments of the dynamic user interface system and associated methodology of the present invention described herein are configured to provide a user with a user interface that is adapted to facilitate utilization of network devices, such as printers, of a network without software associated with each of the network devices being installed at a user's workstation. Preferably, the present invention merely requires modification of the network server, e.g., in the preferred embodiment, software associated with each of the network devices only is installed at the server. So configured, the server is able to provide the user with an interface which allows the user to utilize the newly provided attributes of network devices without associated network device software being installed at the user's workstation.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A method for facilitating network device capability utilization within a network, said method comprising the steps of:
determining attributes of network devices communicating with the network;
enabling a user to select desired attributes of a network device for processing a job; and
facilitating processing of the job at one of the network devices corresponding to the desired attributes selected by the user.

2. The method of claim 1, wherein the step of facilitating processing of the job at one of the network devices comprises:
receiving information corresponding to the desired attributes selected by the user;
providing the user with a selection of network devices possessing attributes corresponding to the desired attributes selected by the user; and
enabling the user to select one of the network devices provided by the selection of network devices for processing the job.

3. The method of claim 1, wherein the step of enabling a user to select desired attributes of a network device for processing a job comprises:
providing the user with a selection of network devices;
receiving information corresponding to a network device selected by the user;
providing the user with attributes corresponding to the network device selected by the user.

4. The method of claim 1, wherein the step of enabling a user to select desired attributes of a network device comprises:
providing a graphical user interface for display to the user, the graphical user interface including a selection of attributes corresponding to attributes possessed by network devices of the network.

5. The method of claim 3, wherein the network devices are printers and the job is a print job.

6. The method of claim 4, wherein the graphical user interface is web-based such that the graphical user interface is viewable via a web browser.

7. The method of claim 5, wherein the step of determining attributes of network devices comprises:
receiving information from a user corresponding to initiation of a print request; and
determining attributes of network devices communicating with the network in response to receiving the information.

8. A system for facilitating network device capability utilization, said system comprising:
a user interface system communicating with a network, said user interface system being configured to determine attributes of network devices communicating with the network, said user interface system providing a user interface;
said user interface being viewable with a web browser and being configured to enable a user to select desired attributes of a network device for processing a job such that said user interface system facilitates processing of the job at one of the network devices corresponding to the desired attributes selected by the user.

9. The system of claim 8, wherein said user interface system resides on a server, said server communicating with the network, and wherein said user interface is generated from the group consisting of a mark-up language and a scripting language.

10. The system of claim 8, further comprising a printer, and wherein one of the network devices is said printer.

11. A computer readable medium having a computer program for facilitating network device capability utilization within a network, said computer readable medium comprising:
logic configured to determine attributes of network devices communicating with the network;
logic configured to enable a user to select desired attributes of a network device for processing a job; and
logic configured to facilitate processing of the job at one of the network devices corresponding to the desired attributes selected by the user.

12. The computer readable medium of claim 11, wherein the logic configured to facilitate processing of the job at one of the network devices comprises:
logic configured to receive information corresponding to the desired attributes selected by the user;
logic configured to provide the user with a selection of network devices possessing attributes corresponding to the desired attributes selected by the user; and
logic configured to enable the user to select one of the network devices provided by the selection of network devices for processing the job.

13. The computer readable medium of claim 11, wherein the logic configured to enable a user to select desired attributes of a network device comprises logic configured to provide a graphical user interface for display to the user, the graphical user interface including a selection of attributes corresponding to attributes possessed by network devices of the network.

14. The computer readable medium of claim 12, wherein the network devices are printers and the job is a print job.

15. The computer readable medium of claim 14, wherein the logic configured to determine attributes of network devices comprises:
logic configured to receive information from a user corresponding to initiation of a print request; and
logic configured to determine attributes of network devices communicating with the network in response to receiving the information.

16. A system for facilitating network device capability utilization within a network, said system comprising:
means for determining attributes of network devices communicating with the network;
means for enabling a user to select desired attributes of a network device for processing a job; and
means for facilitating processing of the job at one of the network devices corresponding to the desired attributes selected by the user.

17. The system of claim 16, wherein said means for facilitating processing of the job at one of the network devices comprises:
means for receiving information corresponding to the desired attributes selected by the user;
means for providing the user with a selection of network devices possessing attributes corresponding to the desired attributes selected by the user; and
means for enabling the user to select one of the network devices provided by the selection of network devices for processing the job.

18. A system for facilitating network device capability utilization, said system comprising:
a user interface system communicating with a network, said user interface system being configured to determine attributes of network devices communicating with the network, said user interface system providing a user interface, said user interface being configured to enable a user to select desired attributes of a network device for processing a job such that said user interface system facilitates processing of the job at one of the network devices corresponding to the desired attributes selected by the user.

19. The system of claim 18, further comprising a printer, and wherein one of the network devices is said printer.

20. The system of claim 18, wherein said user interface is configured to display a printer capabilities field and a printer selection field, said printer capabilities field being configured to display attributes of network devices communicating with the network, each of said attributes being selectable by a user, said printer selection field being configured to display network devices possessing said attributes selected by the user in said printer capabilities field, each of the network devices displayed by said printer selection field being selectable by the user such that the network device selected in said printer selection field processes the job.
